(19) United States
(12) Patent Application Publication
(10) Pub. No.: US 2025/0015515 A1
(43) Pub. Date: Jan. 9, 2025

(54) ELECTRONIC DEVICE FOR CONTROLLING ELECTRONIC DEVICE USING UWB SIGNAL, AND OPERATING METHOD OF ELECTRONIC DEVICE

(71) Applicant: Samsung Electronics Co., Ltd., Suwon-si (KR)

(72) Inventors: Jiho SHIN, Suwon-si (KR); Yi YANG, Suwon-si (KR); Moonseok KANG, Suwon-si (KR); Hyunchul KIM, Suwon-si (KR); Sukgi HONG, Suwon-si (KR)

(21) Appl. No.: 18/891,596

(22) Filed: Sep. 20, 2024

Related U.S. Application Data
(63) Continuation of application No. PCT/KR2023/003502, filed on Mar. 16, 2023.

(30) Foreign Application Priority Data
Mar. 30, 2022 (KR) 10-2022-0039842
Jun. 3, 2022 (KR) 10-2022-0068005

(51) Int. Cl. H01Q 21/28; H04L 25/02

(52) U.S. Cl. CPC H01Q 21/28; H04L 25/0212

(57) ABSTRACT

An electronic device according to various embodiments comprises: a first antenna; a second antenna; a third antenna; a communication module comprising communication circuitry connected to the antennas and including a first receive port (RX) and a second RX; and at least one processor, comprising processing circuitry, wherein the communication module is configured to analyze a pattern of signals, based on signals received from the first RX and the second RX, and transmit information related to the analyzed pattern of signals to at least one processor, and at least one processor, individually and/or collectively, may be configured to perform a designated operation based on the information related to the pattern of signals from the communication module.

### CROSS-REFERENCE TO RELATED APPLICATIONS

This application is a continuation of International Application No. PCT/KR2023/003502 designating the United States, filed on Mar. 16, 2023, in the Korean Intellectual Property Receiving Office and claiming priority to Korean Patent Application Nos. 10-2022-0039842, filed on Mar. 30, 2022, and 10-2022-0068005, filed on Jun. 3, 2022, in the Korean Intellectual Property Office, the disclosures of each of which are incorporated by reference herein in their entireties.

### BACKGROUND

### Field

The disclosure relates to an electronic device for controlling an electronic device using a UWB signal and a method of operating the electronic device. For example, the disclosure relates to an electronic device for controlling an electronic device using a UWB signal in the electronic device having no physical button, and a method of operating the electronic device.

### Description of Related Art

A mobile device includes physical buttons on the exterior to perform various functions. The physical button may be designed to perform a variety of functions, such as power on/off, volume up/down, or a capture function.

The mobile device may include a UWB module. An ultra-wide-band (UWB) is a short-range wireless communication protocol that uses radio waves, such as Bluetooth or WiFi, and is a wireless technology that is capable of precisely measuring a distance with an error range in units of centimeters (cm) using a wideband frequency of 500 megahertz (MHz) or more. An electronic device using the UWB technology may transmit and receive data at low power over a wide frequency band.

The information described above is provided solely as background information to enhance the understanding of the content of the present disclosure. No determination has been made, and no assertion is made, as to whether any of the above-mentioned may be applicable as the prior art in relation to the present disclosure.

### SUMMARY

Embodiments of the disclosure to an electronic device for controlling an electronic device using a UWB module. For example, an electronic device of the present disclosure may perform various functions on the basis of signals received from a UWB antenna.

Embodiments of the disclosure may not include a physical button on the exterior, and may perform a function of the physical button on the basis of signals received from a UWB antenna. For example, an electronic device of the present disclosure may perform power on/off, volume up/down, or a capture function on the basis of signals received from a UWB antenna. For example, an electronic device of the present disclosure may perform various functions by analyzing UWB signals as a user performs an operation, such as a short press, long press, or swipe, on a housing in which a UWB antenna is located.

Technical problems to be addressed by the present disclosure are not limited to the above-mentioned technical problems, and other technical problems, which are not mentioned above, may be clearly understood from the following descriptions by those skilled in the art to which the present disclosure pertains.

An electronic device according to various example embodiments may include: a first antenna, a second antenna, a third antenna, a communication module comprising communication circuitry connected to the antennas and including a first receive port (RX) and a second RX, and at least one processor, comprising processing circuitry, wherein the communication module may be configured to analyze a pattern of signals, based on signals received from the first RX and the second RX, and transmit information related to the analyzed pattern of signals to at least one processor, and at least one processor, individually and/or collectively, may be configured to perform a designated operation based on the information related to the pattern of signals from the communication module.

A method of operating an electronic device according to various example wherein the electronic device may include a first antenna, a second antenna, a third antenna, a communication module comprising communication circuitry connected to the antennas and including a first receive port (RX) and a second RX, and at least one processor comprising processing circuitry, may include: analyzing, by the communication module, a pattern of signals based on the signals received from the first RX and the second RX; and performing, by at least one processor, individually and/or collectively, a designated operation based on information related to the analyzed pattern of signals.

In a non-transitory computer-readable recording medium storing instructions, which, when executed by at least one processor, comprising processing circuitry, of an electronic device, individually and/or collectively, may control a communication module to perform at least one operation. The communication module comprising communication circuitry may be connected to a first antenna, a second antenna, and a third antenna, and may include a first receive port (RX) and a second RX. The instructions, when executed by at least processor, individually and/or collectively, may allow the processor to: analyze a pattern of signals on the basis of signals received by the communication module from the first RX and the second RX; and perform a designated operation based on information related to a pattern of the analyzed signals.

Further aspects will be described in part in the following description, will be apparent in part from the description, or may be understood by those skilled in the art.

For example, an electronic device may not include an external physical key.

For example, process costs may be reduced for an electronic device that does not include an external physical key.

For example, an electronic device may perform a variety of functions using a UWB module.

For example, an electronic device may replace and perform a function of a physical key using a UWB module.

For example, an electronic device may perform a function of powering on and off, or increasing or decreasing volume, using a UWB module.

For example, an electronic device may increase the transmission power and sample rate of a UWB signal to reduce power consumption only when a function is enabled.

In addition, various effects that can be directly or indirectly identified through the present disclosure may be provided.

### BRIEF DESCRIPTION OF THE DRAWINGS

Other aspects, advantages and advantages of certain embodiments of the present disclosure will be more apparent to those skilled in the art from the following detailed description, taken in conjunction with the accompanying drawings, in which:

In connection with the description of the drawings, the same or similar reference numerals may be used for the same or similar elements.

FIG. 1 is a block diagram illustrating an example electronic device in a network environment according to various embodiments;

FIG. 2 is a block diagram illustrating an example configuration of the electronic device according to various embodiments;

FIG. 3 is a flowchart illustrating an example method of analyzing a pattern of an RX reception signal by a UWB in the electronic device, according to various embodiments;

FIG. 4 is a diagram illustrating an example user's operation of the electronic device, according to various embodiments.

FIGS. 5A, 5B, and 5C are graphs illustrating a first pattern, a second pattern, a fifth pattern, and a sixth pattern of a signal in the electronic device, according to various embodiments;

FIGS. 6A, 6B, and 6C are graphs illustrating a seventh pattern, in the electronic device, according to various embodiments;

FIGS. 7A, 7B, and 7C are graphs illustrating an eighth pattern, in the electronic device, according to various embodiments;

FIGS. 8A and 8B are block diagrams illustrating an example configuration of an antenna and a UWB structure, in the electronic device, according to various embodiments;

FIG. 9A is a diagram illustrating an example of the communication module controlling the transmission power and sample rate of a signal, according to various embodiments; and

FIG. 9B is a flowchart illustrating an example operation in which a UWB controls the transmission power and sample rate of a signal, according to various embodiments.

### DETAILED DESCRIPTION

The following description of various example embodiments of the disclosure is made with reference to the accompanying drawings is. Various specific details are included herewith for the purpose of the understanding, but should be considered as illustrative only. Therefore, those skilled in the art will recognize that various alterations and modifications may be made to the various embodiments disclosed in the present disclosure without departing from the scope and spirit of the present disclosure. In addition, for clarity and conciseness, descriptions of well-known features and configurations may be omitted.

The terms and words used in the following descriptions and claims are not limited to their bibliographic meanings, but are used to enable a clear and consistent understanding of the present disclosure. Therefore, it should be apparent to those skilled in the art that the following descriptions of various embodiments of the present disclosure, are not intended to limit the present disclosure, but are provided solely for the purpose of illustration.

The expressions in the singular form should be understood to include the plural referents unless the context clearly dictates otherwise. Therefore, for example, a reference to a “surface of an element” may include a reference to one or more of those surfaces.

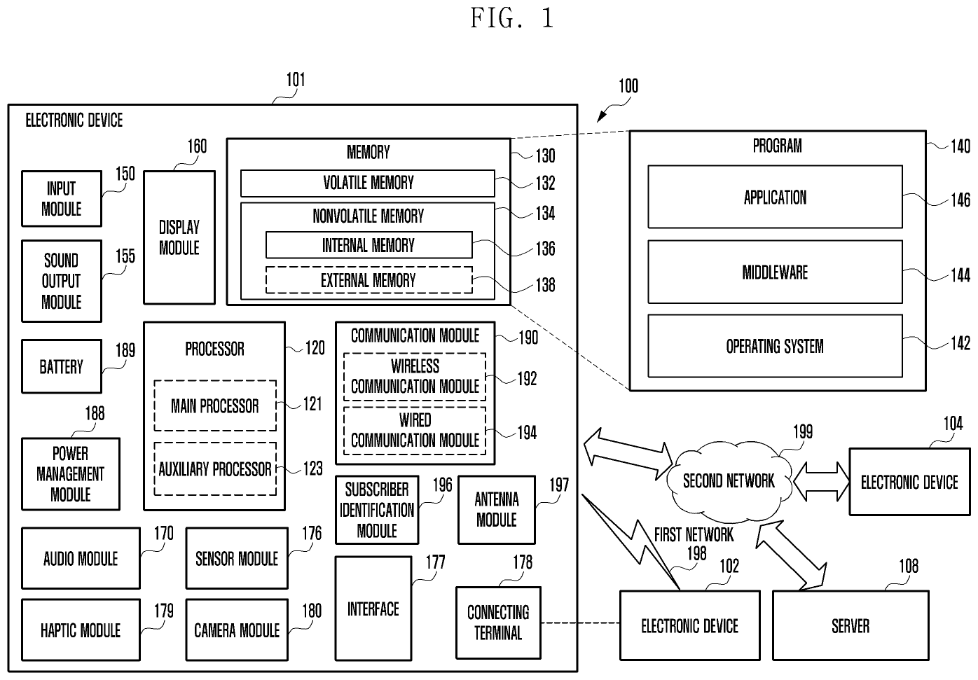

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

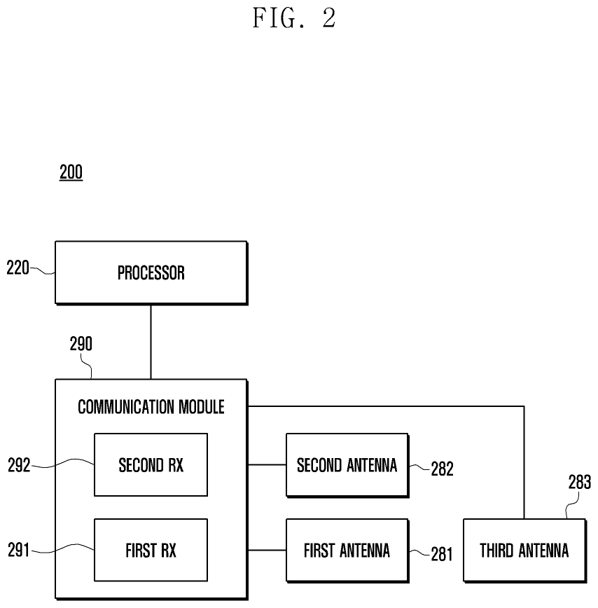

FIG. 2 is a block diagram illustrating an example configuration of the electronic device according to various embodiments.

With reference to FIG. 2, an electronic device 200 (e.g., the electronic device 101 in FIG. 1) may include a processor (e.g., including processing circuitry) 220 (e.g., the processor 120 in FIG. 1), a communication module (e.g., including communication circuitry) 290, a first antenna 281, a second antenna 282, and/or a third antenna 283. The elements included in FIG. 2 are for some of the configurations included in the electronic device 200. In addition, the electronic device 200 may include various elements as illustrated in FIG. 1.

The first antenna 281, the second antenna 282, and/or the third antenna 283, according to various embodiments, may be connected to the communication module 290 to transmit and receive a signal in an ultra-wide-band (UWB) frequency area.

The communication module 290, according to various embodiments, may include various communication circuitry and may include a UWB module that performs communication using an ultra-wide-band (UWB) frequency.

The communication module 290 may include a TX (not illustrated), a first RX 291, a second RX 292, and/or a third RX (not illustrated).

The communication module 290, according to an embodiment, may be one UWB module chipset including a single core and/or a multi-core.

The first RX 291, the second RX 292, and/or the third RX (not illustrated) may obtain a signal received by the first antenna 281, the second antenna 282, and/or the third antenna 283.

The first RX 291, the second RX 292, and/or the third RX (not illustrated), according to various embodiments, may refer, for example, to at least one RX port (receive port) included in the communication module 290. According to an embodiment, the second RX 292 may be connected to the second antenna 281 through a DPDT (not illustrated), and the first RX 291 may be connected to the first antenna 281 and the third antenna 283 through an SPDT (not illustrated). According to an embodiment, the first RX 291 may be connected to the first antenna 281, the second RX 292 may be connected to the second antenna 282, and the third RX (not illustrated) may be connected to the third antenna 283.

The communication module 290, according to various embodiments, may analyze a pattern of a reception signal for each RX.

The communication module 290, according to various embodiments, may control the TX (not illustrated) to adjust the intensity and sample rate of a transmission signal.

For example, the communication module 290 may control the TX (not illustrated) to transmit a signal with a first power and/or a second power greater than the first power. For example, the communication module 290 may control the TX (not illustrated) to transmit a signal at a first sample rate and/or a second sample rate that is higher than the first sample rate.

According to an embodiment, the communication module 290 may control the TX (not illustrated) to adjust the power and/or sample rate of a transmission signal depending on a state of the electronic device 200 and/or a type of application being executed. For example, the communication module 290 may control the TX (not illustrated) to transmit a signal with the first power and at the first sample rate when the electronic device 200 is in a powered-off state. For example, the communication module 290 may control the TX (not illustrated) to transmit a signal with a power lower than the first power and/or at a sample rate lower than the first sample rate when the electronic device 200 is in a powered-off state and in a designated state (e.g., during a user's configured sleep time, in a state where information is obtained to identify that the user is sleeping, in a state where a battery of the electronic device is at a designated level or less and the electronic device is not connected to a charger, and in a state where there has been no CIR change for a designated period of time or more).

The communication module 290, according to various embodiments, may enable and/or disable the first RX 291, the second RX 292, and/or the third RX (not illustrated).

The communication module 290, according to an embodiment, may enable and/or disable the first RX 291, the second RX 292, and/or the third RX (not illustrated) depending on a state of the electronic device 200 and/or a type of application being executed.

For example, the communication module 290 may only enable some (e.g., the first RX 291) of the first RX 291, the second RX 292, and/or the third RX (not illustrated)) when the electronic device 200 is in a powered-off state, and disable the remaining RXs. For example, the communication module 290 may disable all of the first RX 291, the second RX 292, and/or the third RX (not illustrated) when the electronic device 200 is in a powered off state and in a designated state (e.g., when a user is sleeping, when obtaining information to identify that the user is sleeping, when a battery of the electronic device is at a designated level or less, when the electronic device is in a non-charger-connected state, or when there has been no CIR change for a designated period of time or more). For example, the communication module 290 may only enable some (e.g., the first RX 291) of the first RX 291, the second RX 292, and/or the third RX (not illustrated) in a state where a display screen is in a turned-off state, and disable the remaining RXs. For example, the communication module 290 may enable all of the first RX 291, the second RX 292, and/or the third RX (not illustrated) when the display screen is switched from a turned-off state to a turned-on state. For example, the communication module 290 may enable only an RX related to a power key and disable the remaining RXs when the display screen is in a turned-off state and a media file is in a non-executing state. For example, the communication module 290 may enable only an RX related to the power key and disable the remaining RXs when a media file is not being executed and an application is being executed that does not use a volume up/down key. For example, the communication module 290 may disable all of the first RX 291, the second RX 292, and the third RX (not illustrated) in response to receiving information that determines that the user is sleeping from a linked external electronic device.

The communication module 290, according to an embodiment, may transmit and receive a signal in a first state and analyze a pattern of the received signal. For example, the first state may be a state in which the communication module 290 transmits a signal with the first power and at the first sample rate, and only enables the first RX 291 to receive the signal.

The communication module 290, according to an embodiment, may receive an instruction that changes a transmission/reception state of the communication module 290 from the processor 220. For example, the instruction to change the transmission/reception state of the communication module 290 may be an instruction related to enabling a function that controls the electronic device 200 on the basis of a reception signal of the communication module 290.

The communication module 290, according to an embodiment, may transmit and receive a signal to a second state. For example, the second state may be a state in which the communication module 290 transmits a signal with the second power greater than the first power and at the second sample rate higher than the first sample rate, and enables all RXs to receive the signal.

The communication module 290, according to an embodiment, may analyze a pattern of a signal on the basis of the signal received from an RX.

For example, the communication module 290 may analyze a pattern of signals on the basis of the signals received from the first RX 291, the second RX 292, and/or the third RX 293.

For example, the communication module 290 may analyze a pattern of a signal on the basis of a result of comparing a channel impulse response (CIR) of the received signal to a baseline, which is a CIR when there is no motion in the vicinity of an antenna.

For example, the communication module 290 may analyze a pattern of signals in the signals received from the first RX 291, the second RX 292, and/or the third RX 293 on the basis of a result based on a real part, an imaginary part, and/or an absolute part of the channel impulse response (CIR).

For example, the communication module 290 may analyze a pattern of signals in a first RX 191 signal received from the first RX 291, a second RX 292 signal received from the second RX 292, and/or a third RX (not illustrated) signal received from the third RX 293 on the basis of a value that removes a clutter, which is noise, from a result based on a real part, an imaginary part, and/or an absolute part of the channel impulse response (CIR).

A pattern of reception signals, according to an embodiment, may include various forms of signals that the communication module 290 detects by a user's operation related to the antenna. For example, a pattern of reception signals may include a first pattern, a second pattern, a third pattern, a fourth pattern, a fifth pattern, a sixth pattern, a seventh pattern, an eighth pattern, a ninth pattern, and/or a tenth pattern.

For example, the first pattern may be a pattern that corresponds to when a user long-presses a position of the housing corresponding to the first antenna 281, and a pattern in which a peak related to a designated signal (e.g., the first RX 291 signal) is sustained for a designated period of time or more in a result of comparing the channel impulse response (CIR) of the received signal to a baseline.

For example, the second pattern may be a pattern that corresponds to when a user short-presses a position of the housing corresponding to the first antenna 281, and a pattern in which a peak related to a designated signal (e.g., the first RX 291 signal) occurs in a result of comparing the channel impulse response (CIR) of the received signal to the baseline.

For example, the third pattern may be a pattern that corresponds to when a user long-presses a position of the housing corresponding to the second antenna 282, and a pattern in which a peak related to a designated signal (e.g., the second RX 292 signal) occurs in a result of comparing the (CIR) of the received signal to the baseline.

For example, the fourth pattern may be a pattern that corresponds to when a user short-presses a position of the housing corresponding to the second antenna 282, and a pattern in which a peak related to a designated signal (e.g., the second RX 292 signal) occurs in a result of comparing the (CIR) of the received signal to the baseline.

For example, the fifth pattern may be a pattern that corresponds to when a user long-presses a position of the housing corresponding to the third antenna 283, and a pattern in which a peak related to a designated signal (e.g., the second RX 292 signal and/or the third RX 293 signal) is sustained for a designated period of time or more in a result of comparing the (CIR) of the received signal to the baseline.

For example, the sixth pattern may be a pattern that corresponds to when a user short-presses a position of the housing corresponding to the third antenna 283, and a pattern in which a peak related to a designated signal (e.g., the second RX 292 signal and/or the third RX 293 signal) occurs in a result of comparing the (CIR) of the received signal to the baseline.

For example, the seventh pattern may be a pattern corresponding to when a user swipes from a position of the housing corresponding to the first antenna 281 to a position of the housing corresponding to the second antenna 282, and a pattern in which a peak related to a designated signal (e.g., the second RX 292 signal) occurs after a peak related to a designated signal (e.g., the first RX 291 signal) occurs in a result of comparing the channel impulse response (CIR) of the received signal to the baseline.

For example, the eighth pattern may be a pattern corresponding to when a user swipes from a position of the housing corresponding to the second antenna 282 to a position of the housing corresponding to the first antenna 281, and a pattern in which a peak related to a designated signal (e.g., the first RX 291 signal) occurs after a peak related to a designated signal (e.g., the second RX 292 signal) occurs in a result of comparing the channel impulse response (CIR) of the received signal to the baseline.

For example, the ninth pattern may be a pattern corresponding to when a user swipes from a position of the housing corresponding to the first antenna 281 to a position of the housing corresponding to the third antenna 283, and a pattern in which a peak related to a designated signal (e.g., the second RX 292 signal and/or the third RX 293 signal) occurs after a peak related to a designated signal (e.g., the first RX 291 signal) occurs in a result of comparing the channel impulse response (CIR) of the received signal to the baseline.

For example, the tenth pattern may be a pattern corresponding to when a user swipes from a position of the housing corresponding to the third antenna 283 to a position of the housing corresponding to the first antenna 281, and a pattern in which a peak related to a designated signal (e.g., the first RX 291 signal) occurs after a peak related to a designated signal (e.g., the second RX 292 signal and/or the third RX 293 signal) occurs in a result of comparing the channel impulse response (CIR) of the received signal to the baseline.

The communication module 290, according to an embodiment, may transmit information related to the analyzed pattern to the processor 220.

For example, the communication module 290 may transmit information related to a pattern to the processor 220 in response to the pattern of a signal being at least one of the first pattern, the second pattern, the third pattern, the fourth pattern, the fifth pattern, the sixth pattern, the seventh pattern, the eighth pattern, the ninth pattern, or the tenth pattern analyzed on the basis of the signal received from an RX.

The processor 220, according to various embodiments, may include various processing circuitry and be connected to the communication module 290 to perform various functions on the basis of the signals received by the communication module 290. In addition, the processor 220 may transmit an instruction that changes the transmission/reception state of the communication module 290 to the communication module 290. In addition, the processor 220 may control the communication module 290 to disable all, enable some, or enable all of the first RX 291, the second RX 292, and/or the third RX (not illustrated). The processor 220 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 220 may perform a designated operation on the basis of information related to the pattern received from the communication module 290.

For example, the designated operation may include a variety of operations, such as an operation to decrease a sound volume of the electronic device 200, an operation to increase a sound volume of the electronic device 200, an operation to turn on the power, an operation to turn off the power, a capture operation, an operation to adjust a character size in a text application, and an operation to zoom in and/or zoom out when taking an image in a camera application.

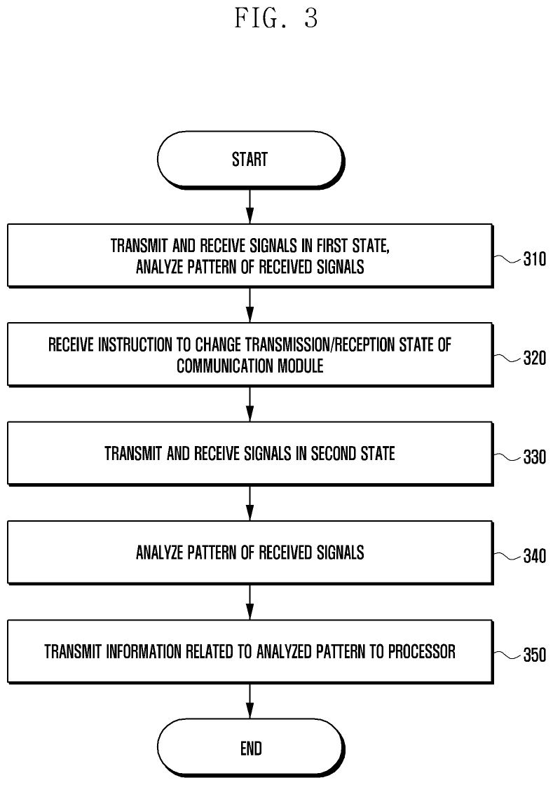

FIG. 3 is a flowchart illustrating an example method in which the communication module 290 analyzes a pattern of an Rx reception signal in the electronic device 200, according to various embodiments.

The communication module 290, according to various embodiments, may control the TX (not illustrated) to adjust the intensity and sample rate of a transmission signal.

For example, the communication module 290 may control the TX (not illustrated) to transmit a signal with a first power and/or a second power greater than the first power. For example, the communication module 290 may control the TX (not illustrated) to transmit a signal at a first sample rate and/or a second sample rate that is higher than the first sample rate.

According to an embodiment, the communication module 290 may control the TX (not illustrated) to adjust the power and/or sample rate of a transmission signal depending on a state of the electronic device 200 and/or a type of application being executed. For example, the communication module 290 may control the TX (not illustrated) to transmit a signal with the first power and at the first sample rate when the electronic device 200 is in a powered-off state. For example, the communication module 290 may control the TX (not illustrated) to transmit a signal with a power lower than the first power and/or at a sample rate lower than the first sample rate when the electronic device 200 is in a powered-off state and in a designated state (e.g., during a user's configured sleep time, in a state where information is obtained to identify that the user is sleeping, in a state where a battery of the electronic device is at a designated level or less and the electronic device is not connected to a charger, and in a state where there has been no CIR change for a designated period of time or more).

The communication module 290, according to various embodiments, may enable and/or disable the first RX 291, the second RX 292, and/or the third RX (not illustrated).

The communication module 290, according to an embodiment, may enable and/or disable the first RX 291, the second RX 292, and/or the third RX (not illustrated) depending on a state of the electronic device 200 and/or a type of application being executed.

For example, the communication module 290 may only enable some (e.g., the first RX 291) of the first RX 291, the second RX 292, and/or the third RX (not illustrated)) when the electronic device 200 is in a powered-off state, and disable the remaining RXs. For example, the communication module 290 may disable all of the first RX 291, the second RX 292, and/or the third RX (not illustrated) when the electronic device 200 is in a powered off state and in a designated state (e.g., when a user is sleeping, when obtaining information to identify that the user is sleeping, when a battery of the electronic device is at a designated level or less, when the electronic device is not connected to a charger, or when there has been no CIR change for a designated period of time or more). For example, the communication module 290 may only enable some (e.g., the first RX 291) of the first RX 291, the second RX 292, and/or the third RX (not illustrated) in a state where a display screen is in a turned-off state, and disable the remaining RXs. For example, the communication module 290 may enable all of the first RX 291, the second RX 292, and/or the third RX (not illustrated) when the display screen is switched from a turned-off state to a turned-on state. For example, the communication module 290 may enable only an RX related to a power key and disable the remaining RXs when the display screen is in a turned-off state and a media file is in a non-executing state. For example, the communication module 290 may enable only an RX related to the power key and disable the remaining RXs when a media file is not being executed and an application is being executed that does not use a volume up/down key. For example, the communication module 290 may disable all of the first RX 291, the second RX 292, and the third RX (not illustrated) in response to receiving information that determines that the user is sleeping from a linked external electronic device.

The communication module 290, according to various embodiments, may control the TX (not illustrated) to transmit a signal with a power lower than the first power and/or at a sample rate lower than the first sample rate, and/or may be in a state in which the first RX 291, the second RX 292, and/or the third RX (not illustrated) are all disabled, prior to operation 310. For example, the communication module 290 may control the TX (not illustrated) to transmit a signal with a power lower than the first power and/or at a sample rate lower than the first sample rate, and/or disable at least one of the first RX 291, the second RX 292, and/or the third RX (not illustrated) in response to when the electronic device 200 is in a powered off state and in a designated state (e.g., when a user is sleeping, when obtaining information to identify that the user is sleeping, when a battery of the electronic device is at a designated level or less, when the electronic device is in a non-charger-connected state, or when there has been no CIR change for a designated period of time or more).

The communication module 290, according to an embodiment, may switch a transmission/reception state to transmit and receive a signal in a first state when the communication module 290 is in a powered-off state and in a designated state (e.g., during a user's waking hours, when obtaining information to identify that the user is waking, when a battery of the electronic device is at a designated level or more, when the electronic device is in a charger-connected state, or when a CIR change is detected within a designated period of time).

The communication module 290, according to various embodiments, may, at operation 310, transmit a signal in the first state, then receive a signal in the first state, and analyze a pattern of the received signal.

For example, the first state may be a state in which the communication module 290 transmits a signal with the first power and at the first sample rate through the TX, enables only the first RX 291 and disables the remaining RXs to receive the signal. For example, the first power may be a power lower than a default configuration of the TX, and the first sample rate may be a sample rate lower than the default configuration of the TX.

The communication module 290, according to an embodiment, may transmit a signal with the first power and at the first sample rate when the electronic device 200 is in a powered-off state, and enable only the first RX 291 to receive the signal. For example, the communication module 290 may identify whether the magnitude of a signal received by the first RX 291 is a threshold or more, and transmit information to the processor 220 that the magnitude of the signal received by the first RX 291 is the threshold or more in response to the threshold or more.

The communication module 290, according to an embodiment, may be in a disabled state in a default state of the electronic device 200. For example, the communication module 290 may, in a default state of the electronic device 200, disable the TX and/or RX to not transmit and receive a signal until a button function of the electronic device 200 is enabled by a user.

The communication module 290, according to various embodiments, may receive, at operation 320, an instruction that changes a transmission/reception state of the communication module 290 from the processor 220.

For example, the instruction to change the transmission/reception state of the communication module 290 may be an instruction related to enabling a function that controls the electronic device 200 on the basis of a reception signal of the communication module 290.

The processor 220, according to an embodiment, may transmit, at operation 310, a command that powers on the electronic device 200 and changes a transmission/reception state of the communication module 290 on the basis of information indicating that the magnitude of the signal received by the first RX 291 is the threshold or more, which is obtained from the communication module 290.

The processor 220, according to an embodiment, may transmit an instruction that changes a transmission/reception state of the communication module 290 to the communication module 290 on the basis of a user's function enabling input (e.g., a UI selection for enabling a function on a display).

At operation 330, the communication module 290, according to various embodiments, may transmit and receive a signal in a second state.

For example, the second state may be a state in which the communication module 290 transmits a signal with the second power greater than the first power and at the second sample rate higher than the first sample rate, and enables all RXs to receive the signal.

According to an embodiment, the communication module 290 may transmit a signal with the second power and at the second sample rate, and enable all RXs to receive the signal, on the basis of an instruction that changes a transmission/reception state of the communication module 290 of the processor 220.

At operation 340, the communication module 290, according to various embodiments, may analyze a pattern of a signal on the basis of the signal received from an RX.

The communication module 290, according to an embodiment, may analyze a pattern of signals on the basis of the signals received from the first RX 291, the second RX 292, and/or the third RX 293.

For example, the communication module 290 may analyze a pattern of a signal on the basis of a result of comparing a channel impulse response (CIR) of the received signal to a baseline.

For example, the communication module 290 may analyze a pattern of signals in the signals received from the first RX 291, the second RX 292, and/or the third RX 293 on the basis of a result based on a real part, an imaginary part, and/or an absolute part of the channel impulse response (CIR).

For example, the communication module 290 may analyze a pattern of signals in the signals received from the first RX 291, the second RX 292, and/or the third RX 293 on the basis of a value that removes a clutter, which is noise, from a result based on a real part, an imaginary part, and/or an absolute part of the channel impulse response (CIR).

According to an embodiment, operation 340 may be performed on the processor (e.g., at least one processor, individually and/or collectively) 220.

A pattern of reception signal, according to an embodiment, is a characteristic form of signal that the communication module 290 detects by a user's operation related to the antenna, and may include a first pattern, a second pattern, a third pattern, a fourth pattern, a fifth pattern, a sixth pattern, a seventh pattern, an eighth pattern, a ninth pattern, and/or a tenth pattern.

The communication module 290, according to various embodiments, may transmit, at operation 350, information related to the analyzed pattern to the processor 220.

According to an embodiment, the communication module 290 may transmit information related to a pattern to the processor 220 in response to the pattern analyzed on the basis of the signal received from an RX being a designated form of pattern (e.g., the first pattern, the second pattern, the third pattern, the fourth pattern, the fifth pattern, the sixth pattern, the seventh pattern, the eighth pattern, the ninth pattern, or the tenth pattern).

According to an embodiment, the processor 220 may perform a designated operation on the basis of information related to the received pattern.

For example, the designated operation may include a variety of operations, such as an operation to decrease a sound volume of the electronic device 200, an operation to increase a sound volume of the electronic device 200, an operation to turn on the power, an operation to turn off the power, and a capture operation.

For example, the processor 220 may perform a first operation in response to information related to the received pattern being information related to the first pattern. For example, the processor 220 may perform a second operation in response to information related to the received pattern being information related to the second pattern. For example, the processor 220 may perform a third operation in response to information related to the received pattern being information related to the third pattern. For example, the processor 220 may perform a fourth operation in response to information related to the received pattern being information related to the fourth pattern. For example, the processor 220 may perform a fifth operation in response to information related to the received pattern being information related to the fifth pattern. For example, the processor 220 may perform a sixth operation in response to information related to the received pattern being information related to the sixth pattern. For example, the processor 220 may perform a seventh operation in response to information related to the received pattern being information related to the seventh pattern. For example, the processor 220 may perform a eighth operation in response to information related to the received pattern being information related to the eighth pattern. For example, the processor 220 may perform a ninth operation in response to information related to the received pattern being information related to the ninth pattern. For example, the processor 220 may perform a tenth operation in response to information related to the received pattern being information related to the tenth pattern.

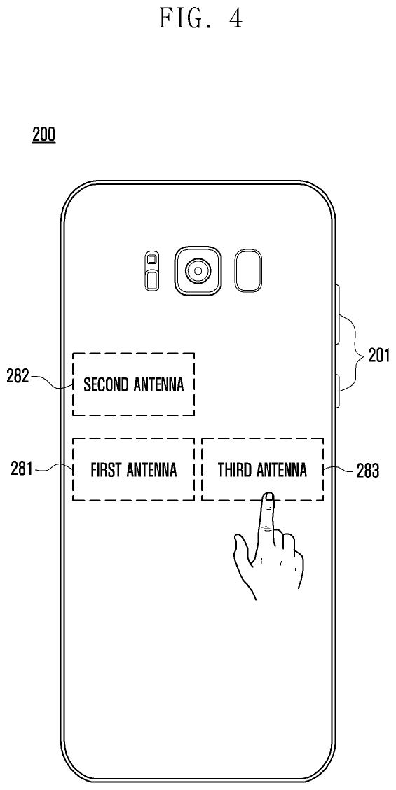

FIG. 4 is a diagram illustrating an example user's operation of the electronic device 200, according to various embodiments.

While the electronic device 200 illustrated in FIG. 4 is shown to include a physical button 201, the electronic device 200 according to various embodiments may or may not include the external physical button 201 to perform a designated function. For example, the electronic device 200 may or may not include the physical button 201 to perform a function of turning the sound volume up or down, and/or turning the power on or off. According to various embodiments, the first antenna 281, the second antenna 282, and/or the third antenna 283 are mounted under a rear surface housing of the electronic device 200 and may be positioned at a designated position.

While FIG. 4 illustrates that the first antenna 281 is positioned under the second antenna 282 and the third antenna 383 is positioned at the right side of the first antenna 281, in addition to this, the first antenna 281, the second antenna 282, and/or the third antenna 283 may be positioned on the electronic device 200 according to various embodiments. For example, the first antenna 281 may be positioned at the right side of the second antenna 282, and the third antenna 383 may be positioned at the lower side of the first antenna 281. According to an embodiment, the third antenna 283 may be positioned under the second antenna 282, and the first antenna 381 may be positioned at the left side of the third antenna 283. According to an embodiment, the third antenna 283 may be positioned at the right side of the second antenna 282, and the first antenna 381 may be positioned at the lower side of the second antenna 282.

According to an embodiment, on the rear surface housing of the electronic device 200, a guide may be displayed that is related to a position in which the first antenna 281, the second antenna 282, and/or the third antenna 283 are mounted.

According to various embodiments, a user may perform a designated operation to enter a designated instruction into a housing corresponding to a position in which the first antenna 281, the second antenna 282, and/or the third antenna 283 are mounted.

For example, the user may long-press a position of the housing corresponding to the first antenna 281.

For example, the user may short-press a position of the housing corresponding to the first antenna 281.

For example, the user may long-press a position of the housing corresponding to the second antenna 282.

For example, the user may short-press a position of the housing corresponding to the second antenna 282.

For example, the user may long-press a position of the housing corresponding to the third antenna 283.

For example, the user may short-press a position of the housing corresponding to the third antenna 283.

For example, the user may swipe from a position of the housing corresponding to the first antenna 281 to a position of the housing corresponding to the second antenna 282.

For example, the user may swipe from a position of the housing corresponding to the second antenna 282 to a position of the housing corresponding to the first antenna 281.

For example, the user may swipe from a position of the housing corresponding to the first antenna 281 to a position of the housing corresponding to the third antenna 283.

For example, the user may swipe from a position of the housing corresponding to the third antenna 283 to a position of the housing corresponding to the first antenna 281.

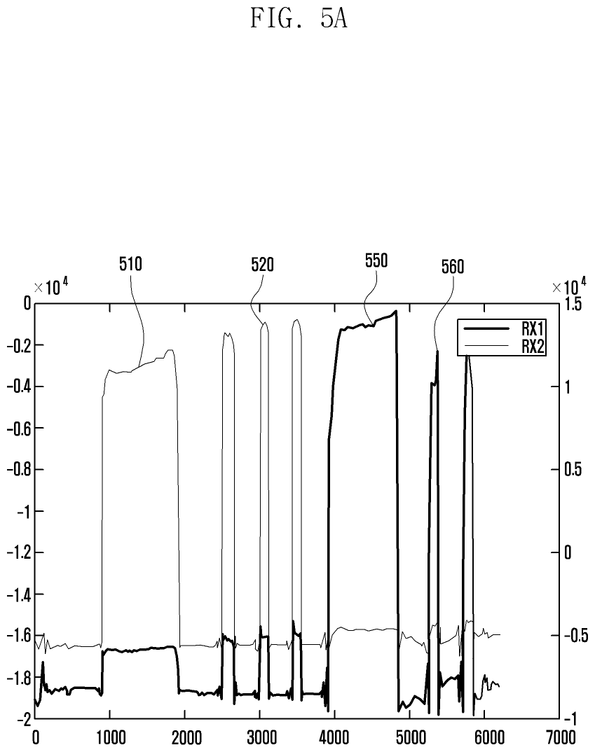

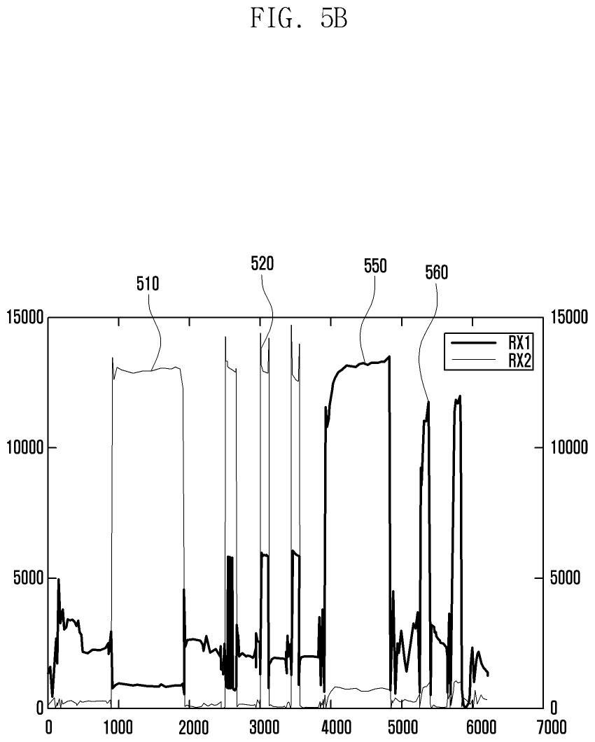

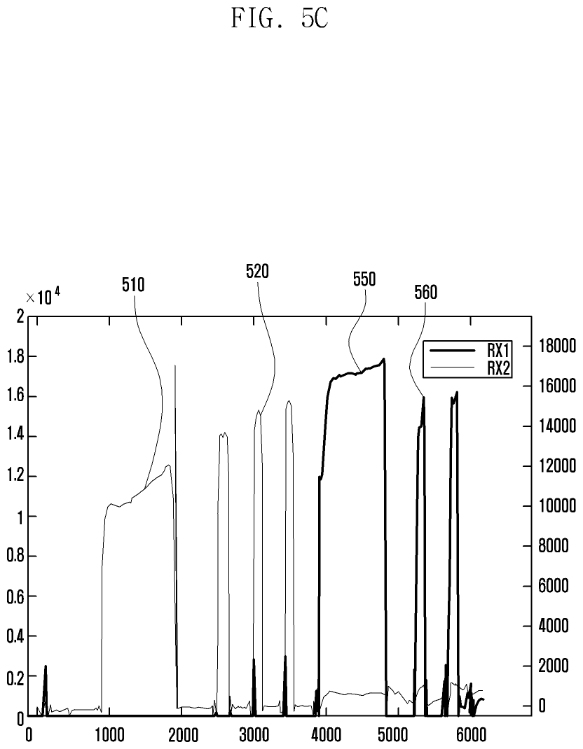

FIGS. 5A, 5B, and 5C are graphs related to the first pattern, the second pattern, the fifth pattern, and the sixth pattern of a signal in the electronic device 200, according to various embodiments.

According to various embodiments, FIGS. 5A, 5B, and 5C may be graphs of various types of signals detected by the communication module 290 according to a user's operation for a position of the housing corresponding to a position of the first antenna 281, second antenna 282, and/or third antenna 283.

According to an embodiment, in the graphs of FIGS. 5A, 5B, and 5C, 510 may be a first pattern, which is a pattern of a signal that corresponds to when the user long-presses a position of the housing corresponding to the first antenna 281.

According to an embodiment, in the graphs of FIGS. 5A, 5B, and 5C, 520 may be a second pattern, which is a pattern of a signal that corresponds to when the user short-presses a position of the housing corresponding to the first antenna 281.

According to an embodiment, in the graphs of FIGS. 5A, 5B, and 5C, 550 may be a fifth pattern, which is a pattern of a signal that corresponds to when the user long-presses a position of the housing corresponding to the third antenna 283.

According to an embodiment, in the graphs of FIGS. 5A, 5B, and 5C, 560 may be a sixth pattern, which is a pattern of a signal that corresponds to when the user long-presses a position of the housing corresponding to the third antenna 283.

According to various embodiments, FIG. 5A may be a view illustrating an imaginary part graph of a channel impulse response (CIR) of a signal received by the communication module 290.

According to various embodiments, FIG. 5B may be a view illustrating an absolute part graph of a channel impulse response (CIR) of a signal received by the communication module 290, with a clutter, which is noise reflected from an immovable object, removed.

According to various embodiments, FIG. 5C may be a view illustrating an imaginary part graph of a channel impulse response (CIR) of a signal received by the communication module 290, with a clutter removed.

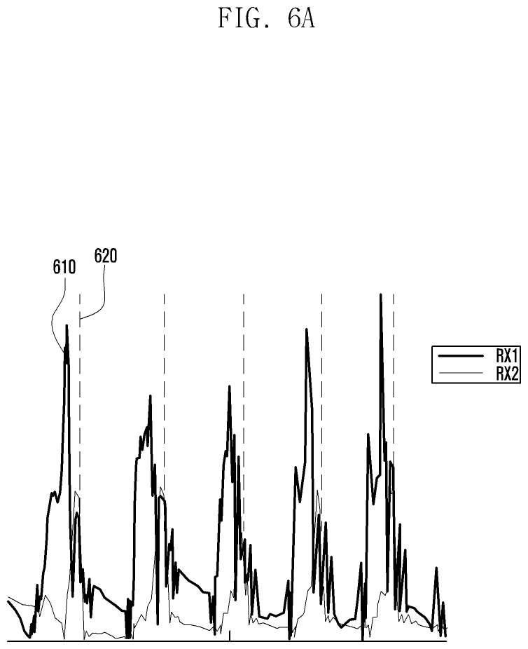

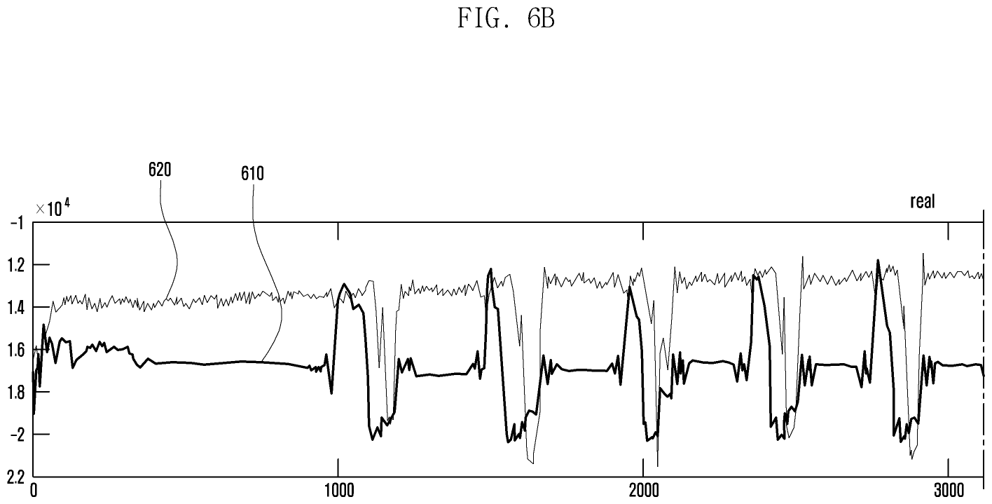

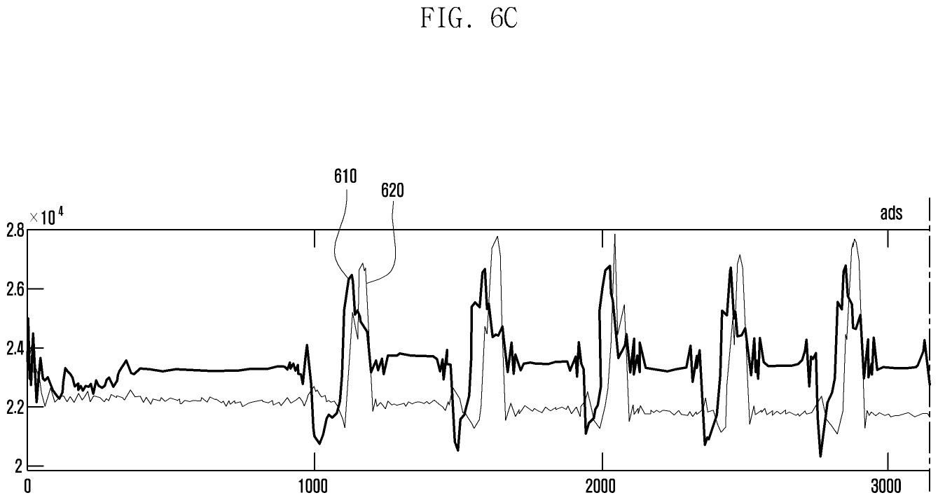

FIGS. 6A, 6B, and 6C are graphs related to the seventh pattern, in the electronic device 200, according to various embodiments.

According to various embodiments, FIGS. 6A, 6B, and 6C may be a signal graph of various types of seventh pattern detected by the communication module 290 in response to an operation in which a user swipes from a position of the housing corresponding to the first antenna 281 to a position of the housing corresponding to the second antenna 282.

According to an embodiment, in the graphs of FIGS. 6A, 6B, and 6C, the seventh pattern may be a pattern in which a peak 610 of a signal corresponding to when the user touches a position of the housing corresponding to the first antenna 281 occurs, and then a peak 620 of a signal corresponding to when the user swipes to a position of the housing corresponding to the second antenna 282 occurs.

According to various embodiments, FIG. 6A may be a view illustrating an absolute part graph of a channel impulse response (CIR) of a signal received by the communication module 290, with a clutter, which is noise reflected from an immovable object, removed.

According to various embodiments, FIG. 6B may be a view illustrating a real part graph of a channel impulse response (CIR) of a signal received by the communication module 290.

According to various embodiments, FIG. 6C may be a view illustrating an absolute part graph of a channel impulse response (CIR) of a signal received by the communication module 290.

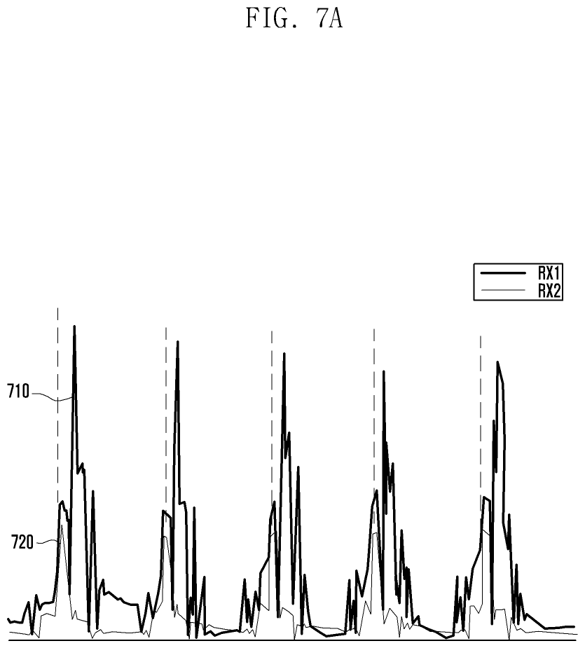

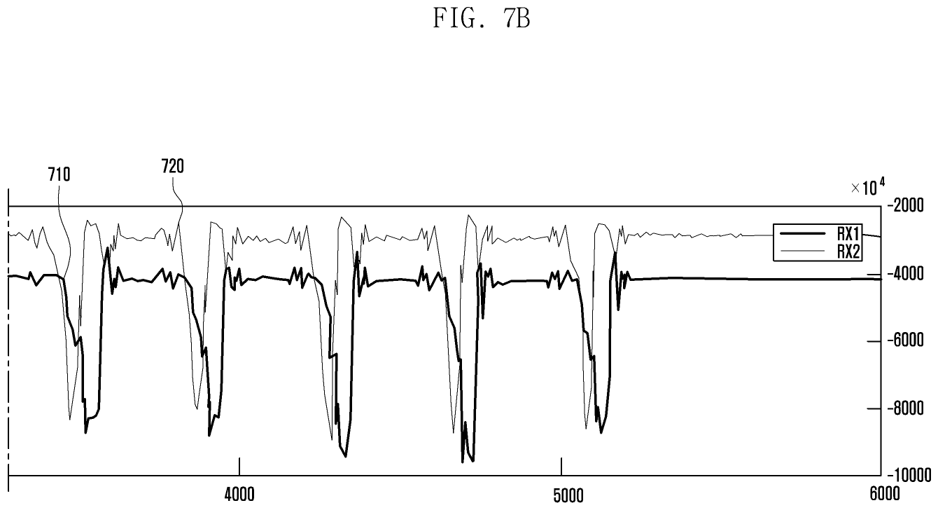

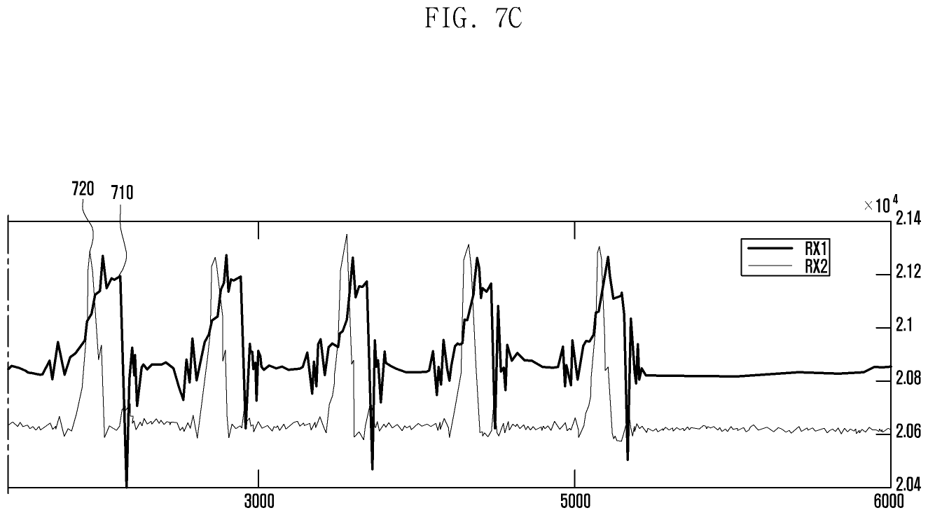

FIGS. 7A, 7B, and 7C are graphs related to the eighth pattern, in the electronic device 200, according to various embodiments.

According to various embodiments, FIGS. 7A, 7B, and 7C may be a signal graph of various types of eighth pattern detected by the communication module 290 in response to an operation in which a user swipes from a position of the housing corresponding to the second antenna 282 to a position of the housing corresponding to the first antenna 281.

According to an embodiment, in the graphs of FIGS. 7A, 7B, and 7C, the eighth pattern may be a pattern in which a peak 710 of a signal corresponding to when the user touches a position of the housing corresponding to the second antenna 282 occurs, and then a peak 720 of a signal corresponding to when the user swipes to a position of the housing corresponding to the first antenna 281 occurs.

According to various embodiments, FIG. 7A may be a view illustrating an absolute part graph of a channel impulse response (CIR) of a signal received by the communication module 290, with a clutter, which is noise reflected from an immovable object, removed.

According to various embodiments, FIG. 7B may be a view illustrating a real part graph of a channel impulse response (CIR) of a signal received by the communication module 290.

According to various embodiments, FIG. 7C may be a view illustrating an absolute part graph of a channel impulse response (CIR) of a signal received by the communication module 290.

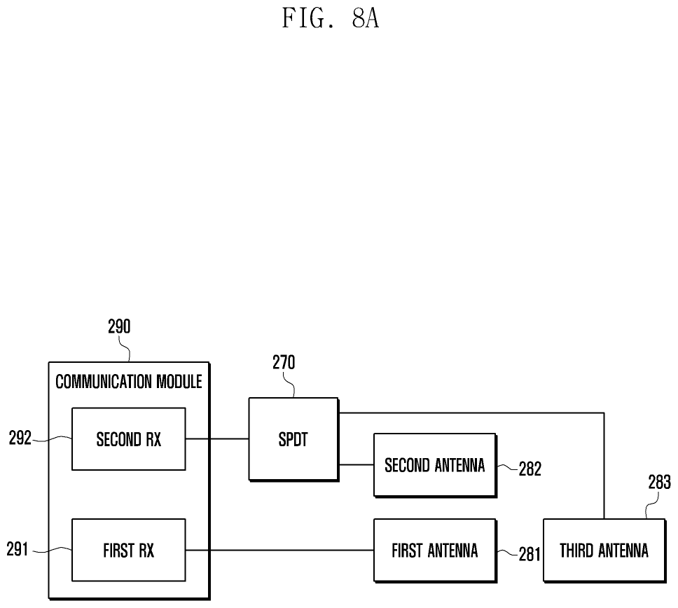

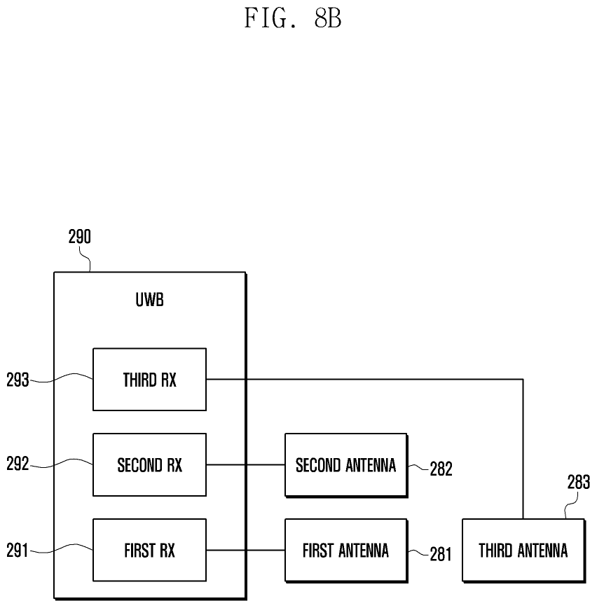

FIGS. 8A and 8B are block diagrams illustrating example configurations of an antenna and the communication module 290, in the electronic device 200, according to various embodiments.

The electronic device 200, according to various embodiments, may include an antenna and the communication module 290 as illustrated in FIG. 8A or FIG. 8B.

FIG. 8A is a block diagram illustrating an example configuration of the communication module 290 that supports an antenna and two RXs in the electronic device 200, according to various embodiments.

The electronic device 200, according to various embodiments, may include the first antenna 281, the second antenna 282, the third antenna 283, single pole double throw (SPDT) switch 270, and/or the communication module (e.g., including communication circuitry) 290 that supports two RXs.

The communication module 290, according to various embodiments, may include the first RX 291 and the second RX 292.

The first RX 291, according to an embodiment, may be connected to the first antenna 281 to obtain a signal received by the first antenna 281.

The second RX 292, according to an embodiment, may be connected to the second antenna 282 and the third antenna 283 to obtain a signal received by the second antenna 282 and/or a signal received by the third antenna 283.

The SPDT, according to an embodiment, may include a switch to distinguish between the signal received by the second antenna 282 and/or the signal received by the third antenna 283, and transmit the distinguished information to the second RX 292.

The communication module 290, according to various embodiments, may analyze a pattern of a signal on the basis of the signal obtained from the first RX 291 and/or the second RX 292, and transmit information related to the analyzed pattern to the processor 220.

FIG. 8B is a block diagram illustrating an example configuration of the communication module 290 that supports an antenna and three RXs in the electronic device 200, according to various embodiments.

The electronic device 200, according to various embodiments, may include the first antenna 281, the second antenna 282, the third antenna 283, and/or the communication module (e.g., including communication circuitry) 290 that supports three RXs.

The communication module 290, according to various embodiments, may include the first RX 291, the second RX 292, and the third RX 293.

The first RX 291, according to an embodiment, may be connected to the first antenna 281 to obtain a signal received by the first antenna 281.

The second RX 292, according to an embodiment, may be connected to the second antenna 282 to obtain a signal received by the second antenna 282.

The third RX 293, according to an embodiment, may be connected to the third antenna 283 to obtain a signal received by the third antenna 283.

The communication module 290, according to various embodiments, may analyze a pattern of a signal on the basis of the signal obtained from the first RX 291, the second RX 292, and/or the third RX 293, and transmit information related to the analyzed pattern to the processor 220.

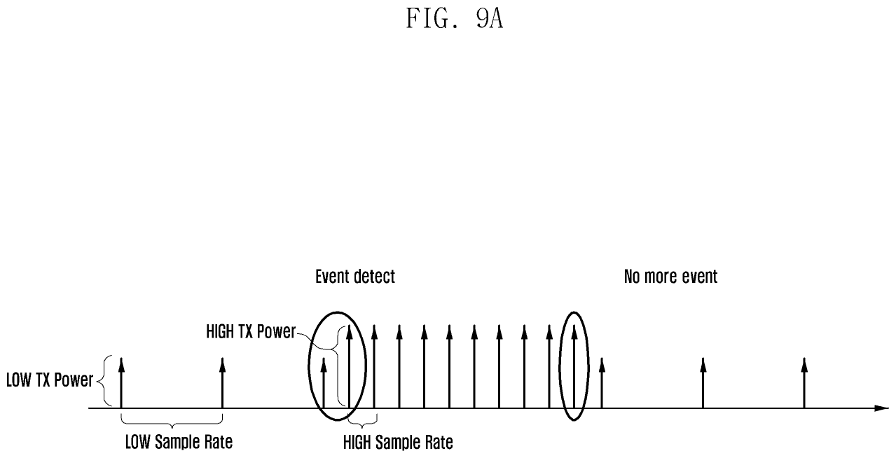

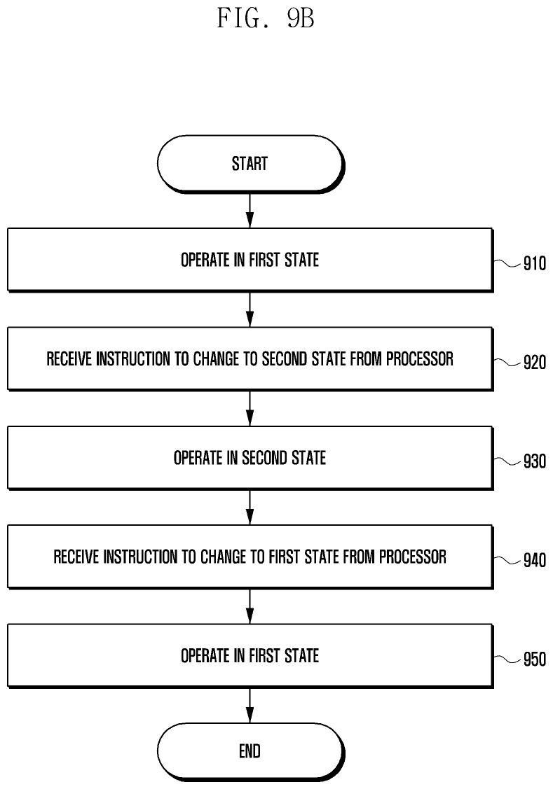

FIG. 9A is a diagram illustrating an example of the communication module 290, according to various embodiments, controlling the transmission power and sample rate of a signal.

FIG. 9B is a flowchart illustrating an example method by which the communication module 290 controls the transmission power and sample rate of a signal according to various embodiments.

At operation 910, the communication module 290, according to various embodiments, may operate in a first state.

The first state may be a state in which the communication module 290 transmits a signal with the first power (low TX power) and at the first sample rate (low sample rate).

The communication module 290, according to an embodiment, may transmit a signal with the first power and at the first sample rate and enable only the first RX 291 to receive the signal. For example, the communication module 290 may identify whether the magnitude of a signal received by the first RX 291 is a threshold or more, and transmit information to the processor 220 that the magnitude of the signal received by the first RX 291 is the threshold or more in response to the threshold or more.

The communication module 290, according to various embodiments, may receive, at operation 920, an instruction that changes a transmission/reception state of the communication module 290 to the second state, from the processor 220.

The processor 220, according to an embodiment, may transmit an instruction to the communication module 290 that powers on the electronic device 200 and changes the transmission/reception state of the communication module 290 to the second state on the basis of information (event detection) that the magnitude of the signal received by the first RX 291, which is obtained from the communication module 290, is the threshold or more.

The processor 220, according to an embodiment, may transmit an instruction to the communication module 290 that changes the transmission/reception state of the communication module 290 to the second state on the basis of a user's button function enabling input (e.g., a UI selection for enabling a button function on a display).

At operation 930, the communication module 290, according to various embodiments, may operate in the second state.

The second state may be a state in which the communication module 290 transmits a signal with the second power (high TX power) greater than the first power and at the second sample rate (high sample rate) higher than the first sample rate.

According to an embodiment, the communication module 290 may transmit a signal with the second power and at the second sample rate, and enable all RXs to receive the signal, on the basis of an instruction that changes the transmission/reception state of the communication module 290 of the processor 220.

The communication module 290, according to various embodiments, may receive, at operation 940, an instruction that changes a transmission/reception state of the communication module 290 to the first state, from the processor 220.

The processor 220, according to an embodiment, may transmit an instruction to the communication module 290 that changes the transmission/reception state of the communication module 290 to the first state on the basis of information (no more event) that the magnitude of the signal received by the first RX 291, which is obtained from the communication module 290, is below the threshold value.

The processor 220, according to an embodiment, may transmit an instruction to the communication module 290 that changes the transmission/reception state of the communication module 290 to the first state on the basis of a user's button function disabling input (e.g., a UI selection for disabling a button function on a display).

At operation 950, the communication module 290, according to various embodiments, may operate in the first state.

According to an embodiment, the communication module 290 may transmit a signal with the first power and at the first sample rate, enable only the first RX 291, and disable the remaining RXs to receive the signal, on the basis of the instruction that changes the transmission/reception state of the communication module 290 of the processor 220 to the first state.

An electronic device, according to various example embodiments, may include a first antenna, a second antenna, and a third antenna,
a communication module comprising communication circuitry connected to the antennas and including a first receive port (RX) and a second RX, and
at least one processor, comprising processing circuitry, wherein the communication module may be configured to analyze a pattern of signals based on signals received from the first RX and the second RX, and transmit information related to the analyzed pattern of signals to at least one processor, wherein at least one processor, individually and/or collectively, may be configured to perform a designated operation based on the information related to the pattern of signals from the communication module.

In the electronic device according to various example embodiments, the communication module may be configured to: transmit a signal with a first power and at a first sample rate in a state in which the electronic device is in a powered-off state, operate in a first state in which only the first RX is enabled to receive a signal, identify whether a signal received by the first RX is a threshold or more, transmit, in response to the signal being the threshold or more, information to at least one processor that the magnitude of the signal received by the first RX is the threshold or more, and at least one processor, individually and/or collectively, may be configured to, based on the information, power on the electronic device, and control the communication module to transmit a signal with a second power and at a second sample rate and operate in a second state in which all RXs are enabled to receive a signal.

In the electronic device according to various example embodiments, the communication module may be configured to analyze a pattern of signals, in signals received from the first RX and the second RX, based on a result based on a real part, an imaginary part, and/or an absolute part of a channel impulse response (CIR).

In the electronic device according to various example embodiments, the communication module may be configured to analyze a pattern of signals, in signals received from the first RX and the second RX, based on a value that removes a clutter, including noise, from a result based on a real part, an imaginary part, and/or an absolute part of a channel impulse response (CIR).

In the electronic device according to various example embodiments, the communication module may be configured to transmit information related to the analyzed signals to at least one processor in response to a pattern of the analyzed signals corresponding to a designated pattern.

In the electronic device according to various example embodiments, the designated pattern may include a pattern in which a peak related to a designated signal occurs in a signal resulting from comparing a channel impulse response (CIR) of a received signal to a baseline CIR based on there being no motion in the vicinity of the antenna, and at least one processor, individually and/or collectively, may be configured to perform a function corresponding to a short-press.

In the electronic device according to various example embodiments, the designated pattern may include a pattern in which a peak related to a designated signal occurs for a designated period of time or more in a signal resulting from comparing a channel impulse response (CIR) of a received signal to a baseline, and at least one processor, individually and/or collectively, may be configured to perform a function corresponding to a long-press.

In the electronic device according to various example embodiments, the designated pattern may include a pattern in which a peak related to a signal different from a designated signal occurs after a peak related to the designated signal occurs in a signal resulting from comparing a channel impulse response (CIR) of a received signal to a baseline, and at least one processor, individually and/or collectively, may be configured to perform a function corresponding to a swipe.

In the electronic device according to various example embodiments, the designated operation may include at least one of an operation of increasing a sound volume of the electronic device, an operation of decreasing the sound volume, an operation of powering the electronic device off, an operation of powering the electronic device on, an operation of adjusting a font size, or an operation of zooming in and/or zooming out when taking an image.

In the electronic device according to various example embodiments, the communication module may further include a third RX, in which the first RX may be connected to a first antenna, the second RX may be connected to a second antenna, and the third RX may be connected to a third antenna, and the communication module may be configured to analyze a pattern of signals based on signals received from the first RX, the second RX, and the third RX.

A method of operating an electronic device, according to various example embodiments, in which the electronic device may include a first antenna, a second antenna, a third antenna, a communication module, comprising communication circuitry, connected to the antennas and including a first receive port (RX) and a second RX, and at least one processor, comprising processing circuitry, may include: analyzing, by the communication module, a pattern of signals based on signals received from the first RX and the second RX, and performing, by at least one processor, a designated operation based on information related to a pattern of the analyzed signals.

The method, according to various example embodiments, may include: transmitting, by the communication module, a signal with a first power and at a first sample rate in a state in which the electronic device is in a powered-off state and operating in a first state in which only the first RX is enabled to receive a signal, identifying, by the communication module, whether a signal received by the first RX is a threshold or more, transmitting, by the communication module, in response to the signal being the threshold or more, information to at least one processor that the magnitude of the signal received by the first RX is the threshold or more, powering on, by at least one processor, individually and/or collectively, the electronic device based on the information, and controlling, by at least one processor, individually and/or collectively, the communication module to transmit a signal with a second power and at a second sample rate and operate in a second state in which all RXs are enabled to receive a signal.

The method, according to various example embodiments, may include analyzing, by the communication module, a pattern of signals, in signals received from the first RX and the second RX, based on a result based on a real part, an imaginary part, and/or an absolute part of a channel impulse response (CIR).

The method, according to various example embodiments, may include analyzing, by the communication module, a pattern of signals, in signals received from the first RX and the second RX, based on a value that removes a clutter, including noise, from a result based on a real part, an imaginary part, and/or an absolute part of a channel impulse response (CIR).

The method, according to various example embodiments, may include transmitting, by the communication module, information related to the analyzed signals to at least one processor in response to a pattern of the analyzed signals corresponding to a designated pattern.

In the method, according to various example embodiments, the designated pattern may include a pattern in which a peak related to a designated signal occurs in a signal resulting from comparing a channel impulse response (CIR) of a received signal to a baseline CIR based on there being no motion in the vicinity of the antenna, and the method may include performing, by at least one processor, individually and/or collectively, a function corresponding to a short-press.

In the method, according to various example embodiments, the designated pattern may include a pattern in which a peak related to a designated signal occurs for a designated period of time or more in a signal resulting from comparing a channel impulse response (CIR) of a received signal to a baseline, and the method may include performing, by at least one processor, individually and/or collectively, a function corresponding to a long-press.

In the method, according to various example embodiments, the designated pattern may include a pattern in which a peak related to a signal different from a designated signal occurs after a peak related to the designated signal occurs in a signal resulting from comparing a channel impulse response (CIR) of a received signal to a baseline, and the method may include performing, by at least one processor, individually and/or collectively, a function corresponding to a swipe.

In the method, according to various example embodiments, the designated operation may include at least one of: increasing a sound volume of the electronic device, decreasing the sound volume, powering the electronic device off, powering the electronic device on, adjusting a font size, or zooming in and/or zooming out when taking an image.

In the method, according to various example embodiments, the communication module may further include a third RX, in which the first RX may be connected to a first antenna, the second RX may be connected to a second antenna, and the third RX may be connected to a third antenna, and the method may include analyzing, by the communication module, a pattern of signals based on signals received from the first RX, the second RX, and the third RX.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “Ist” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments thereof, it will be understood by those skilled in the art that various modifications in the forms and details may be made without departing from the true spirit and full scope of the disclosure including the appended claims and their equivalents. It will also be understood that any of the embodiment(s) described herein may be used in conjunction with any other embodiment(s) described herein.

What is claimed is:

1. An electronic device comprising:
a first antenna, a second antenna, and a third antenna;
a communication module comprising communication circuitry connected to the antennas and including a first receive port (RX) and a second RX;
and at least one processor, comprising processing circuitry,
wherein the communication module is configured to analyze a pattern of signals based on signals received from the first RX and the second RX, and transmit information related to the analyzed pattern of signals to at least one processor, and
wherein at least one processor, individually and/or collectively, is configured to perform a designated operation based on the information related to the pattern of signals from the communication module.

2. The electronic device of claim 1, wherein the communication module is configured to transmit a signal with a first power and at a first sample rate in a state in which the electronic device is in a powered-off state, operate in a first state in which only the first RX is enabled to receive a signal, identify whether a signal received by the first RX is a threshold or more, transmit, in response to the signal being the threshold or more, information to at least one processor that the magnitude of the signal received by the first RX is the threshold or more, and
wherein at least one processor, individually and/or collectively, is configured to, based on the information, power on the electronic device, and control the communication module to transmit a signal with a second power and at a second sample rate and operate in a second state in which all RXs are enabled to receive a signal.

3. The electronic device of claim 1, wherein the communication module is configured to analyze a pattern of signals, in signals received from the first RX and the second RX, based on a result based on a real part, an imaginary part, and/or an absolute part of a channel impulse response (CIR).

4. The electronic device of claim 1, wherein the communication module is configured to analyze a pattern of signals, in signals received from the first RX and the second RX, based on a value that removes a clutter, including noise, from a result based on a real part, an imaginary part, and/or an absolute part of a channel impulse response (CIR).

5. The electronic device of claim 1, wherein the communication module is configured to transmit information related to the analyzed signals to at least one processor in response to a pattern of the analyzed signals corresponding to a designated pattern.

6. The electronic device of claim 5, wherein the designated pattern includes a pattern in which a peak related to a designated signal occurs in a signal resulting from comparing a channel impulse response (CIR) of a received signal to a baseline CIR based on there being no motion in the vicinity of the antenna, and
wherein at least one processor, individually and/or collectively, is configured to perform a function corresponding to a short-press.

7. The electronic device of claim 5, wherein the designated pattern includes a pattern in which a peak related to a designated signal occurs for a designated period of time or more in a signal resulting from comparing a channel impulse response (CIR) of a received signal to a baseline, and
wherein at least one processor, individually and/or collectively, is configured to perform a function corresponding to a long-press.

8. The electronic device of claim 1, wherein the designated pattern includes a pattern in which a peak related to a signal different from a designated signal occurs after a peak related to the designated signal occurs in a signal resulting from comparing a channel impulse response (CIR) of a received signal to a baseline, and
wherein at least one processor, individually and/or collectively, is configured to perform a function corresponding to a swipe.

9. The electronic device of claim 1, wherein the designated operation includes at least one of an operation of: increasing a sound volume of the electronic device, decreasing the sound volume, powering the electronic device off, powering the electronic device on, adjusting a font size, or zooming in and/or zooming out when taking an image.

10. The electronic device of claim 1, wherein the communication module further includes a third RX,
wherein the first RX is connected to a first antenna, the second RX is connected to a second antenna, and the third RX is connected to a third antenna, and
wherein the communication module is configured to analyze a pattern of signals based on signals received from the first RX, the second RX, and the third RX.

11. A method of operating an electronic device, wherein the electronic device includes a first antenna, a second antenna, a third antenna, a communication module comprising communication circuitry connected to the antennas and including a first receive port (RX) and a second RX, and at least one processor, comprising processing circuitry,
the method comprising:
analyzing, by the communication module, a pattern of signals based on signals received from the first RX and the second RX; and
performing, by at least one processor, individually and/or collectively, a designated operation based on information related to a pattern of the analyzed signals.

12. The method of claim 11, comprising:
transmitting, by the communication module, a signal with a first power and at a first sample rate in a state in which the electronic device is in a powered-off state and operating in a first state in which only the first RX is enabled to receive a signal;
identifying, by the communication module, whether a signal received by the first RX is a threshold or more;
transmitting, by the communication module, in response to the signal being the threshold or more, information to at least one processor that the magnitude of the signal received by the first RX is the threshold or more;
powering on, by at least one processor, individually and/or collectively, the electronic device based on the information; and
controlling, by at least one processor, individually and/or collectively, the communication module to transmit a signal with a second power and at a second sample rate and operate in a second state in which all RXs are enabled to receive a signal.

13. The method of claim 11, comprising:
analyzing, by the communication module, a pattern of signals, in signals received from the first RX and the second RX, based on a result based on a real part, an imaginary part, and/or an absolute part of a channel impulse response (CIR).

14. The method of claim 11, comprising:
analyzing, by the communication module, a pattern of signals, in signals received from the first RX and the second RX, based on a value that removes a clutter, including noise, from a result based on a real part, an imaginary part, and/or an absolute part of a channel impulse response (CIR).

15. The method of claim 11, comprising:
transmitting, by the communication module, information related to the analyzed signals to at least one processor in response to a pattern of the analyzed signals corresponding to a designated pattern.

16. The method of claim 15, wherein the designated pattern includes a pattern in which a peak related to a designated signal occurs in a signal resulting from comparing a channel impulse response (CIR) of a received signal to a baseline CIR based on there being no motion in the vicinity of the antenna, and
performing, by at least one processor, individually and/or collectively, a function corresponding to a short-press.

17. The method of claim 15, wherein the designated pattern includes a pattern in which a peak related to a designated signal occurs for a designated period of time or more in a signal resulting from comparing a channel impulse response (CIR) of a received signal to a baseline, and
the method further comprising:
performing, by at least one processor, individually and/or collectively, a function corresponding to a long-press.

18. The method of claim 11, wherein the designated pattern includes a pattern in which a peak related to a signal different from a designated signal occurs after a peak related to the designated signal occurs in a signal resulting from comparing a channel impulse response (CIR) of a received signal to a baseline, and
the method further comprising:
performing, by at least one processor, individually and/or collectively, a function corresponding to a swipe.

19. The method of claim 11, wherein the designated operation includes at least one of an operation of: increasing a sound volume of the electronic device, decreasing the sound volume, powering the electronic device off, powering the electronic device on, adjusting a font size, or zooming in and/or zooming out when taking an image.

20. The method of claim 11, wherein the communication module further includes a third RX,
wherein the first RX is connected to a first antenna, the second RX is connected to a second antenna, and the third RX is connected to a third antenna, and
the method comprising:
analyzing, by the communication module, a pattern of signals based on signals received from the first RX, the second RX, and the third RX.
